(19) United States
(12) Patent Application Publication
(10) Pub. No.: US 2022/0172152 A1
(43) Pub. Date: Jun. 2, 2022

(54) TRANSPORTATION MANAGEMENT DEVICE, TRANSPORTATION MANAGEMENT SYSYTEM, TRANSPORTATION MANAGEMENT METHOD, AND TRANSPORTATION MANAGEMENT PROGRAM

(71) Applicant: TOYOTA JIDOSHA KABUSHIKI KAISHA, Toyota-shi Aichi-ken (JP)

(72) Inventors: Takaaki Yanagihashi, Toyota-shi (JP); Takahiro Okano, Chiryu-shi (JP); Toru Takashima, Susono-shi (JP); Hiroaki Kiyokami, Nisshin-shi (JP); Kenta Miyahara, Okazaki-shi (JP); Yohei Tanigawa, Toyota-shi (JP)

(73) Assignee: TOYOTA JIDOSHA KABUSHIKI KAISHA, Toyota-shi Aichi-ken (JP)

(21) Appl. No.: 17/480,471

(22) Filed: Sep. 21, 2021

(30) Foreign Application Priority Data
Nov. 30, 2020 (JP) 2020-198435

(51) Int. Cl. G06Q 10/08

(52) U.S. Cl. CPC G06Q 10/083

(57) ABSTRACT

A center server including a CPU is provided. The CPU instructs a vehicle to transport a part from a supplier of the part to a supply destination, instructs, after the vehicle has transported the part, the vehicle to move from the supply destination to a stopover and to load another part at the stopover, and instructs the vehicle to deliver the other part to one or more delivery points located in a direction from the stopover toward the supplier.

### CROSS-REFERENCE TO RELATED APPLICATION

This application claims priority to Japanese Patent Application No. 2020-198435 filed on Nov. 30, 2020, incorporated herein by reference in its entirety.

### BACKGROUND

### 1. Technical Field

The present disclosure relates to a transportation management device, a transportation management system, a transportation management method, and a transportation management program.

### 2. Description of Related Art

A technique related to a transportation system for transporting articles from a place of shipment to a destination using a loading container has been proposed. Japanese Unexamined Patent Application Publication No. 2004-123258 (JP 2004-123258 A) describes an automobile transportation system and an automobile transportation method that enable efficient transportation of automobiles and with which various departments on the transportation route can transmit and receive information to and from each other via a network so as to know the transportation status.

### SUMMARY

Although there is a technique related to a transportation system for transporting articles from the place of shipment to the destination as described above, there is still room for improvement in terms of efficient transportation using vehicles that have transported parts.

The present disclosure has been made in view of the above points, and it is an object of the present disclosure to provide a transportation management device, a transportation management system, a transportation management method, and a transportation management program that improve efficiency of transportation by using vehicles that have transported parts.

A transportation management device according to a first aspect includes a processor. The processor instructs a vehicle to transport a part from a supplier of the part to a supply destination, instructs, after the vehicle has transported the part, the vehicle to move from the supply destination to a stopover and to load another part at the stopover, and instructs the vehicle to deliver the other part to one or more delivery points located in a direction from the stopover toward the supplier.

In the transportation management device according to the first aspect, the processor instructs a vehicle to transport a part from a supplier of the part to a supply destination, instructs, after the vehicle has transported the part, the vehicle to move from the supply destination to a stopover and to load another part at the stopover. The processor instructs the vehicle to deliver the other part to one or more delivery points located in a direction from the stopover toward the supplier. With the transportation management device according to the first aspect, the vehicle that has transported a part is used for delivering another part, so that the efficiency of transportation can be improved.

According to a transportation management device according to a second aspect, in the transportation management device according to the first aspect, the processor causes a common transporter to be used for transporting the part and delivering the other part.

In the transportation management device according to the second aspect, the processor causes a common transporter to be used for transporting the part and delivering the other part. With the transportation management device according to the second aspect, the common transporter is used for transporting the part and for delivering the other part, so that the efficiency of transportation can be improved.

According to a transportation management device according to a third aspect, in the transportation management device according to the first or second aspect, the processor selects, from a plurality of vehicles heading for the supply destination, a vehicle that most fits a delivery plan from the stopover.

In the transportation management device according to the third aspect, the processor selects, from a plurality of vehicles heading for the supply destination, a vehicle that most fits a delivery plan from the stopover. With the transportation management device according to the third aspect, it is possible to cause a vehicle that can improve the efficiency of transportation the most to deliver the other part.

According to a transportation management device according to a fourth aspect, in the transportation management device according to the third aspect, the processor selects, as the vehicle that most fits the delivery plan from the stopover, a vehicle that has agreed on delivery from the stopover.

In the transportation management device according to the fourth aspect, the processor selects, as the vehicle that most fits the delivery plan from the stopover, a vehicle that has agreed on delivery from the stopover. With the transportation management device according to the fourth aspect, vehicles that do not agree on delivery can be excluded from the delivery plan, and the efficiency of delivery of the other part can be further improved.

According to a transportation management device according to a fifth aspect, in the transportation management device according to the third aspect, the processor generates the delivery plan based on information on the other part.

In the transportation management device according to the fifth aspect, the processor generates the delivery plan based on information on the other part. With the transportation management device according to the fifth aspect, the delivery plan is generated based on the information on the other part to deliver the other part, so that the efficiency of transportation can be improved.

According to a transportation management device according to a sixth aspect, in the transportation management device according to the fifth aspect, the processor generates the delivery plan based on demand information of the other part as the information on the other part.

In the transportation management device according to the sixth aspect, the processor generates the delivery plan based on demand information of the other part as the information on the other part. With the transportation management device according to the sixth aspect, the delivery plan is generated based on the demand information of the other part to deliver the other part, so that the efficiency of transportation can be improved.

According to a transportation management device according to a seventh aspect, in the transportation management device according to the sixth aspect, the processor generates the delivery plan based on the demand information obtained based on malfunction information of another vehicle.

In the transportation management device according to the seventh aspect, the processor generates the delivery plan based on the demand information obtained based on acquired malfunction information of another vehicle. With the transportation management device according to the seventh aspect, the delivery plan of the part, for which demand is expected to increase, can be generated based on the demand information obtained based on the malfunction information of another vehicle, to deliver the other part, so that the efficiency of transportation can be improved.

According to a transportation management device according to an eighth aspect, in the transportation management device according to the sixth or seventh aspect, the processor generates the delivery plan based on the demand information obtained based on weather information.

In the transportation management device according to the eighth aspect, the processor generates the delivery plan based on the demand information obtained based on weather information. With the transportation management device according to the eighth aspect, the delivery plan of the part, for which demand is expected to increase, can be generated based on the demand information obtained based on the weather information, to deliver the other part, so that the efficiency of transportation can be improved.

According to a transportation management device according to a ninth aspect, in the transportation management device according to the first aspect, when there is no other part to deliver, the processor makes an instruction that movement to the stopover is unnecessary to the vehicle.

In the transportation management device according to the ninth aspect, when there is no other part to deliver, the processor makes an instruction that movement to the stopover is unnecessary to the vehicle. With the transportation management device according to the ninth aspect, when there is no other part to deliver, an instruction is made that movement to the stopover is unnecessary to the vehicle, so that the efficiency of transportation can be improved.

A transportation management system according to a tenth aspect includes: the transportation management device according to any one of the first to ninth aspects; and one or more vehicles that receive an instruction from the transportation management device. In the transportation management system according to the tenth aspect, as the number of vehicles connected to the transportation management device increases, the efficiency of transportation of both the part and the other part can be improved.

A transportation management method according to an eleventh aspect is performed through execution of processes by a processor. The processes includes: instructing a vehicle to transport a part from a supplier of the part to a supply destination; instructing, after the vehicle has transported the part, the vehicle to move from the supply destination to a stopover and to load another part at the stopover; and instructing the vehicle to deliver the other part to one or more delivery points located in a direction from the stopover toward the supplier.

In the transportation management method according to the eleventh aspect, the processor instructs a vehicle to transport a part from a supplier of the part to a supply destination, and instructs, after the vehicle has transported the part, the vehicle to move from the supply destination to a stopover and to load another part at the stopover. The processor instructs the vehicle to deliver the other part to one or more delivery points located in a direction from the stopover toward the supplier. With the transportation management method according to the eleventh aspect, the vehicle that has transported a part is used for delivering another part, so that the efficiency of transportation can be improved.

A transportation management program according to a twelfth aspect causes a computer to execute processes including: instructing a vehicle to transport a part from a supplier of the part to a supply destination; instructing, after the vehicle has transported the part, the vehicle to move from the supply destination to a stopover and to load another part at the stopover; and instructing the vehicle to deliver the other part to one or more delivery points located in a direction from the stopover toward the supplier.

The transportation management program according to the twelfth aspect causes a computer to instruct a vehicle to transport a part from a supplier of the part to a supply destination, instruct, after the vehicle has transported the part, the vehicle to move from the supply destination to a stopover and to load another part at the stopover, and instruct the vehicle to deliver the other part to one or more delivery points located in a direction from the stopover toward the supplier. With the transportation management program according to the twelfth aspect, the vehicle that has transported a part is used for delivering another part, so that the efficiency of transportation can be improved.

According to the present disclosure, it is possible to provide a transportation management device, a transportation management system, a transportation management method, and a transportation management program that improve efficiency of transportation using a vehicle that has transported a part.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a transportation management system according to the present embodiment;

FIG. 2 is a diagram showing an example of a hardware configuration of a vehicle;

FIG. 3 is a diagram showing an example of a hardware configuration of a center server;

FIG. 4 is a diagram showing an example of a functional configuration of the center server;

FIG. 5 is a flowchart showing an example of a transportation management method performed by the center server;

FIG. 6 illustrates the transportation management method performed by the center server; and

FIG. 7 is a diagram showing an example of information regarding a transportation instruction generated by the center server.

### DETAILED DESCRIPTION OF EMBODIMENTS

Hereinafter, an example of an embodiment of the present disclosure will be described with reference to the drawings. The same reference signs are assigned to the same or equivalent components and parts in the drawings. In addition, the dimensional ratios in the drawings are exaggerated for convenience of description and may differ from the actual ratios.

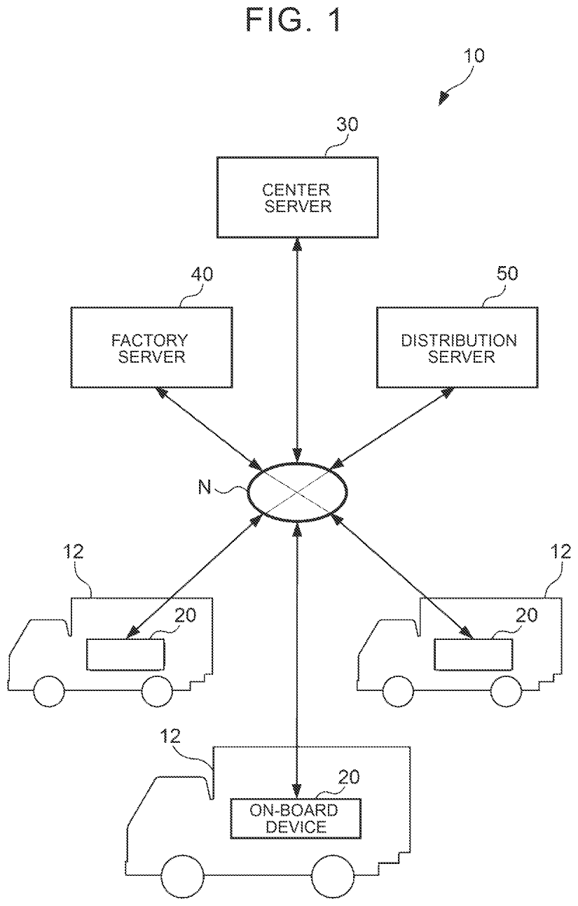

FIG. 1 is a diagram showing a schematic configuration of a transportation management system according to the present embodiment. As shown in FIG. 1, a transportation management system 10 according to the present embodiment includes a plurality of vehicles 12, a center server 30, a factory server 40, and a distribution server 50. Although three vehicles 12 are shown in FIG. 1, the number of vehicles 12 is not limited to this example.

The vehicles 12 are vehicles used for transporting articles, and are, for example, trucks. Each vehicle 12 includes an on-board device 20. The vehicles 12 according to the present embodiment transport, as the articles, parts used the products, for example.

The on-board devices 20 of the vehicles 12, the center server 30, the factory server 40, and the distribution server 50 are connected to each other via a network N.

The center server 30 is an example of a transportation management device. The center server 30 is a server that generates instructions for the vehicles 12 and notifies the vehicles 12 of the instructions. The factory server 40 is a server that manages a factory that manufactures parts or products. The distribution server 50 is a server that manages distribution of parts or products manufactured in the factory.

### Vehicle

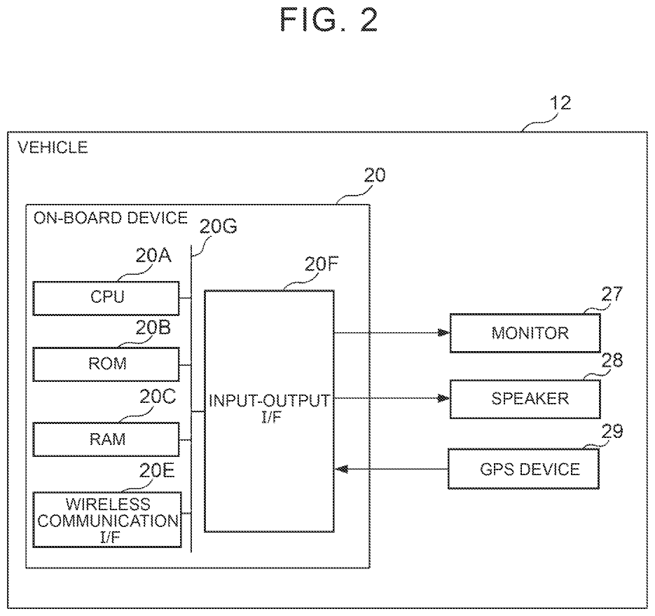

FIG. 2 is a diagram showing an example of a hardware configuration of the vehicle. As shown in FIG. 2, the vehicle 12 according to the present embodiment includes the on-board device 20. The vehicle 12 further includes a monitor 27, a speaker 28, and a Global Positioning System (GPS) device 29.

The on-board device 20 includes a central processing unit (CPU) 20A, a read-only memory (ROM) 20B, a random access memory (RAM) 20C, a wireless communication interface (I/F) 20E, and an input-output I/F 20F. The CPU 20A, the ROM 20B, the RAM 20C, the wireless communication I/F 20E and the input-output I/F 20F are connected so as to be able to communicate with each other via an internal bus 20G.

The CPU 20A is a central processing unit that executes various programs and controls various units. That is, the CPU 20A reads the program from the ROM 20B and executes the program using the RAM 20C as a work area.

The ROM 20B stores various programs and various data. The ROM 20B of the present embodiment stores a control program for controlling the on-board device 20.

The RAM 20C temporarily stores a program or data as a work area.

The wireless communication I/F 20E is a wireless communication module for communicating with the center server 30, the factory server 40, and the distribution server 50. For the wireless communication module, for example, communication standards such as 5th Generation Mobile Communication System (5G), Long Term Evolution (LTE), and Wi-Fi (registered trademark) are used. The wireless communication I/F 20E is connected to the network N.

The input-output I/F 20F is an interface for communicating with the monitor 27, the speaker 28, and the GPS device 29 mounted on the vehicle 12.

The monitor 27 is a liquid crystal monitor provided on an instrument panel, a meter panel, or the like for displaying an image related to the current position, a traveling route, and caution information. The monitor 27 may be provided with a touch panel that also serves as a switch for inputting an operation by the occupant's fingers.

The speaker 28 is a device provided in an instrument panel, a center console, a front pillar, a dashboard, or the like for outputting a sound.

The GPS device 29 is a device that measures the current position of the vehicle 12. The GPS device 29 includes an antenna (not shown) that receives signals from GPS satellites.

### Center Server

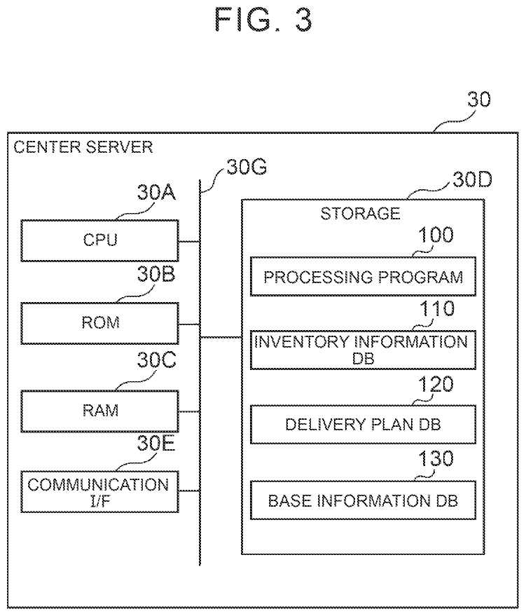

FIG. 3 is a diagram showing an example of a hardware configuration of the center server. As shown in FIG. 3, the center server 30 includes a CPU 30A, a ROM 30B, a RAM 30C, a storage 30D, and a communication I/F 30E. The CPU 30A, the ROM 30B, the RAM 30C, the storage 30D, and the communication I/F 30E are connected so as to be able to communicate with each other via an internal bus 30G. The functions of the CPU 30A, the ROM 30B, the RAM 30C and the communication I/F 30E are the same as those of the CPU 20A, the ROM 20B, the RAM 20C and the wireless communication I/F 20E of the on-board device 20 described above.

The storage 30D is composed of a hard disk drive (HDD) or a solid state drive (SSD), and stores various programs and various data.

The CPU 30A reads a processing program 100 from the storage 30D and executes the processing program 100 using the RAM 30C as a work area.

The processing program 100, an inventory information database (DB) 110, a delivery plan DB 120, and a base information DB 130 are recorded in the storage 30D of the present embodiment.

The processing program 100 is an example of a transportation management program, and is a program for realizing each function of the center server 30.

The inventory information DB 110 is a database that stores inventory information of parts. The inventory information DB 110 stores information on the amount of inventory for each part as the inventory information.

The delivery plan DB 120 is a database that stores the delivery plan of the part for the vehicle 12. The delivery plan DB 120 stores, for example, information on the vehicle for transporting a part from a base to another base, a date and time of transportation, a part to be transported, a transportation source of the part, and a transportation destination of the part, as a delivery plan.

The base information DB 130 is a database that stores information on the base related to delivery of the part. The base information DB 130 stores, for example, information for identifying the base, information on the type of the base, and information on the location of the base as the information on the base.

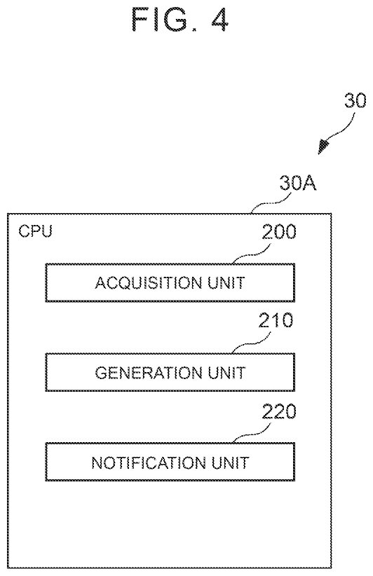

FIG. 4 is a diagram showing an example of a functional configuration of the center server. In the center server 30 of the present embodiment, the CPU 30A executes the processing program 100 to function as an acquisition unit 200, a generation unit 210, and a notification unit 220 shown in FIG. 4.

The acquisition unit 200 acquires the information recorded in the inventory information DB 110, the delivery plan DB 120, and the base information DB 130.

The generation unit 210 uses the information acquired by the acquisition unit 200 to generate information to be notified to the vehicle 12. Specifically, the generation unit 210 uses the information acquired by the acquisition unit 200 from the inventory information DB 110, the delivery plan DB 120, and the base information DB 130 to generate information for causing the vehicle 12 to transport the part from the supplier of the part to the supply destination. In addition, the generation unit 210 generates information for instructing the vehicle 12 that has transported the part to the supply destination to move from the supply destination to a predetermined stopover and to load another part at the stopover and instructing the vehicle 12 to deliver the other part to one or more delivery points located in the direction from the stopover toward the supplier. The vehicle 12 uses a common transporter such as a container or a pallet when transporting the part from the supplier of the part to the supply destination and when delivering the other part from the stopover to the delivery points.

In the present embodiment, “transportation” means delivering an article from the supplier to the supply destination, and “delivery” means delivering the article from a place where the article is retained to another place.

The generation unit 210 may refer to the information stored in the base information DB 130 when generating the information for making an instruction to deliver the other part to one or more delivery points located in the direction from the stopover toward the supplier. By referring to the base information DB 130, the generation unit 210 can select, from the delivery points, a delivery point located in the direction from the stopover toward the supplier.

When there is a plurality of candidate stopovers for the vehicle 12 to move from the supply destination, the generation unit 210 may select a stopover that meets a predetermined condition from the candidate stopovers. For example, the generation unit 210 may select, as the stopover that meets a predetermined condition, a stopover near the supply destination, or a stopover that stores the part to be delivered by the vehicle 12.

When there is a plurality of vehicles 12 heading for the supply destination, the generation unit 210 selects, from the vehicles 12, the vehicle that most fits the delivery plan from the stopover. For example, when moving the vehicle 12 to the stopover, the generation unit 210 may generate information for instructing only the vehicle that has agreed on the delivery from the stopover to move to the stopover.

In addition, the generation unit 210 generates a delivery plan for the vehicle 12 to transport the part. For example, the generation unit 210 manages the inventory of the part based on the demand information of the other part, and generates a delivery plan of the part from the stopover to the delivery point, as needed.

For example, the generation unit 210 may manage the inventory of the part based on the demand information acquired by the acquisition unit 200 based on the malfunction information of the vehicle that is different from the vehicle 12, and may generate a delivery plan for the part from the stopover to the delivery point, as needed. The vehicle malfunction information may be acquired by the acquisition unit 200 from each vehicle, for example, through the execution of a self-diagnosis function of each vehicle. When the demand for a specific part is expected to increase based on the vehicle malfunction information, the generation unit 210 may generate a delivery plan for delivering the part to the supply destination.

For example, the generation unit 210 may manage the inventory of the part based on the demand information obtained based on weather information, and may generate a delivery plan of the part from the stopover to the delivery point, as needed. For example, when it is found that it will snow in a few days ahead as a result of referring to the weather information, the generation unit 210 may generate a delivery plan of parts used for products that are often used during snowfall such as tire chains or studless winter tires.

The notification unit 220 notifies the on-board device 20 of the target vehicle 12 of the information generated by the generation unit 210 through the network N. When the on-board device 20 receives the notification, the CPU 20A of the on-board device 20 displays on the monitor 27 the information based on the received notification.

### Flow of Control

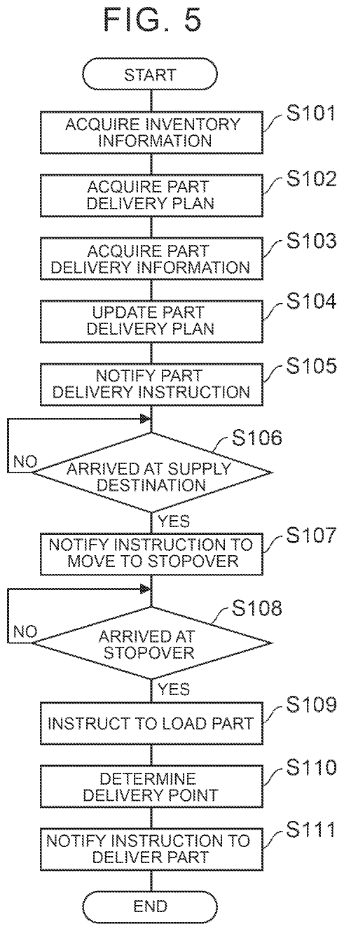

Next, the flow of control by the center server 30 will be described. FIG. 5 is a flowchart showing an example of the flow of the transportation management method performed by the center server 30. The transportation management method shown in FIG. 5 is performed by the CPU 30A through execution of the processing program 100.

The CPU 30A acquires the inventory information of the part from the inventory information DB 110 (step S101).

Following step S101, the CPU 30A acquires information on the delivery plan of the part for which the inventory information was acquired in step S101, from the delivery plan DB 120 (step S102).

Following step S102, the CPU 30A acquires the delivery information of the part for which the inventory information was acquired in step S101 (step S103). The delivery information of the part is, for example, information indicating which part was delivered, and when, from where, to where, and how much the product was delivered.

Following step S103, the CPU 30A updates the information on the delivery plan of the part using the acquired delivery information of the part (step S104).

Following step S104, the CPU 30A notifies the vehicle 12 that delivers the part of a part delivery instruction based on the information on the delivery plan of the part updated in step S104 (step S105). Upon receiving the notification from the center server 30, the driver of the vehicle 12 loads the part on the vehicle 12 based on the notification, and the part is transported from the supplier (for example, the factory of the part) to the supply destination (for example, the factory of the product for which the part is used).

Following step S105, the CPU 30A determines whether the vehicle 12 has arrived at the supply destination of the part (step S106). The CPU 30A may determine whether the vehicle 12 has arrived at the supply destination of the part, based on the position information acquired by the GPS device 29 of the vehicle 12, for example.

When the CPU 30A determines that the vehicle 12 has not arrived at the supply destination of the part (step S106; No), the CPU 30A repeats the process of step S106 until the vehicle 12 arrives at the supply destination of the part.

When the CPU 30A determines that the vehicle 12 has arrived at the supply destination of the part (step S106; Yes), the CPU 30A notifies the vehicle 12 of an instruction to move from the supply destination to the stopover (step S107). The stopover is, for example, a place where parts different from the part for which delivery is notified in step S105 are stored, such as a warehouse. When there is a plurality of candidate stopovers in the direction toward the supply destination, the stopover closest to the supply destination may be set as the stopover for the vehicle 12 to move to.

Following step S107, the CPU 30A determines whether the vehicle 12 has arrived at the stopover (step S108). The CPU 30A may determine whether the vehicle 12 has arrived at the stopover, based on the position information acquired by the GPS device 29 of the vehicle 12, for example.

When the CPU 30A determines in step S108 that the vehicle 12 has not arrived at the stopover (step S108; No), the CPU 30A repeats the process of step S108 until the vehicle 12 arrives at the stopover.

When the CPU 30A determines in step S108 that the vehicle 12 has arrived at the stopover (step S108; Yes), the CPU 30A notifies the vehicle 12 that delivers the part of an instruction to load the part at the stopover (step S109). The CPU 30A determines the part for which the CPU 30A makes an instruction to load at the stopover, based on the information on the delivery plan of the part updated in step S104 and the information on the part stored at the stopover, for example.

Following step S109, the CPU 30A determines the delivery point to which the vehicle 12 is directed from the stopover (step S110). The delivery point to which the vehicle 12 is directed from the stopover is located between the stopover and the supplier of the part. The CPU 30A may determine only one delivery point to which the vehicle 12 is directed from the stopover, or may determine a plurality of delivery points.

Following step S110, the CPU 30A notifies the vehicle 12 that delivers the part of the instruction to deliver the part from the stopover toward the delivery destination that is determined in step S110 (step S111).

The center server 30 executes a series of processes shown in FIG. 5, so as to be able to output a notification for causing the vehicle 12 that has delivered the part from the supplier of the part to the supply destination to deliver another part when returning to the supplier. The center server 30 outputs the notification for causing the vehicle 12 to deliver the other part when returning to the supplier, so that the center server 30 can improve the efficiency of transportation by the vehicle 12 compared with a case where the vehicle 12 does not deliver the other part.

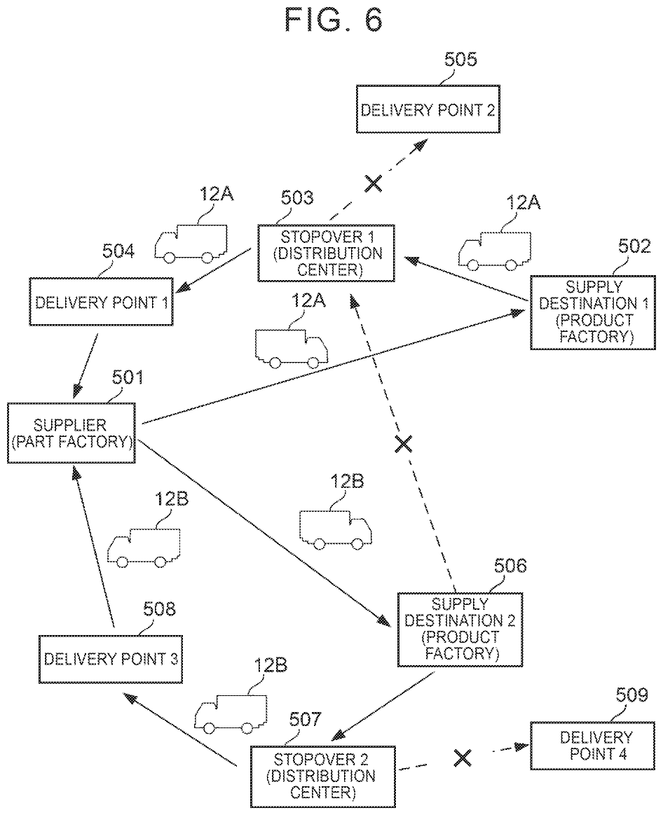

The transportation management method performed by the center server 30 will be described with reference to FIG. 6. A vehicle 12A is a vehicle instructed by the center server 30 to deliver a part from a supplier 501 to a supply destination 502. The supplier 501 is, for example, a part factory, and the supply destination 502 is a product factory that manufactures products using the part supplied from the supplier 501.

The vehicle 12A that has transported the part from the supplier 501 to the supply destination 502 based on the instruction from the center server 30 receives an instruction from the center server 30 to move to a stopover 503. The stopover 503 is, for example, a distribution center that stores parts different from the part transported from the supplier 501 to the supply destination 502. When arriving at the stopover 503, the vehicle 12A loads a part at the stopover 503 and delivers the part to a delivery destination 504 located in the direction from the stopover 503 toward the supplier 501, based on the instruction from the center server 30. That is, the center server 30 does not select a delivery destination 505 that is not located in the direction from the stopover 503 toward the supplier 501, as the delivery destination.

Similarly, a vehicle 12B is a vehicle instructed by the center server 30 to deliver a part from the supplier 501 to a supply destination 506. The supply destination 506 is a product factory that manufactures products using the part supplied from the supplier 501.

The vehicle 12B that has transported the part from the supplier 501 to the supply destination 506 based on the instruction from the center server 30 receives an instruction from the center server 30 to move to a stopover 507. Here, the center server 30 instructs the vehicle 12B to move to the stopover 507 near the supply destination 506 rather than the stopover 503 far from the supply destination 506. The stopover 507 is, for example, a distribution center that stores parts different from the part transported from the supplier 501 to the supply destination 506.

When arriving at the stopover 507, the vehicle 12B loads a part at the stopover 507 and delivers the part to a delivery destination 508 located in the direction from the stopover 507 toward the supplier 501, based on the instruction from the center server 30.

That is, the center server 30 does not select a delivery destination 509 that is not located in the direction from the stopover 507 toward the supplier 501, as the delivery destination.

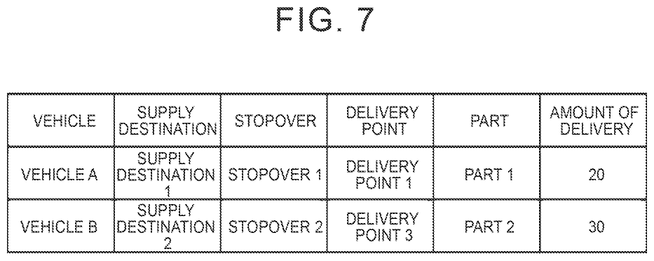

FIG. 7 is a diagram showing an example of information regarding a transportation instruction generated by the CPU 30A of the center server 30 in the example shown in FIG. 6. In the example of FIG. 7, the vehicle 12A is represented as “vehicle A” and the vehicle 12B is represented as “vehicle B”.

In the example of FIG. 7, the CPU 30A of the center server 30 generates an instruction for the vehicle A to transport 20 pieces of a part 1 to the delivery destination 504 (delivery destination 1) via the stopover 503 (stopover 1) after transporting a part to the supply destination 502 (supply destination 1), and notifies the vehicle A of the instruction.

Also in the example of FIG. 7, the CPU 30A of the center server 30 generates an instruction for the vehicle B to transport 30 pieces of a part 2 to the delivery destination 508 (delivery destination 3) via the stopover 507 (stopover 2) after transporting a part to the supply destination 506 (supply destination 2), and notifies the vehicle B of the instruction.

Thus, the center server 30 can instruct the vehicle 12 that has transported the part from the supplier to the supply destination to deliver a part to a delivery destination located in the direction from the stopover toward the supplier on the return route to the supplier after transportation of the part. The center server 30 instructs the vehicle 12 to deliver the part to the delivery destination located in the direction from the stopover toward the supplier, so that the center server 30 can improve the efficiency of transportation by the vehicle 12 compared with a case where no such instruction is made.

On the return route to the supplier after the transportation of the part, it is conceivable that there is no part that should be delivered to the delivery destination located in the direction from the stopover toward the supplier. When there is no such part, the center server 30 may instruct the vehicle 12 that has transported the part to return from the supply destination to the supplier without stopping anywhere. The center server 30 instructs the vehicle 12 that has transported the part to return from the supply destination to the supplier without stopping anywhere when there is no part that should be transported after the transportation of the part, so that the vehicle 12 can immediately return to the supplier, which can improve the efficiency of transportation by the vehicle 12.

It should be noted that various processors other than the CPU may execute the transportation management process that is executed by the CPU reading the software (program) in each of the above embodiments. Examples of the processors in this case include a programmable logic device (PLD) such as a field-programmable gate array (FPGA) for which a circuit configuration can be changed after production, a dedicated electric circuit that is a processor having a circuit configuration designed exclusively for executing a specific process, such as an application specific integrated circuit (ASIC), and the like. In addition, the transportation management process may be executed by one of these various processors, or a combination of two or more processors of the same type or different types (for example, a combination of FPGAs and a combination of a CPU and an FPGA, and the like). Further, the hardware structure of these various processors is, more specifically, an electric circuit in which circuit elements such as semiconductor elements are combined.

Further, in each of the above embodiments, the mode in which the program of the transportation management process is stored (installed) in the ROM or the storage in advance has been described, but the present disclosure is not limited to this. The program may be recorded on a non-transitory recording medium such as a compact disc read-only memory (CD-ROM), a digital versatile disc read-only memory (DVD-ROM), and a universal serial bus (USB) memory to be provided. Further, the program may be downloaded from an external device via a network.

What is claimed is:

1. A transportation management device, comprising a processor, wherein the processor instructs a vehicle to transport a part from a supplier of the part to a supply destination, instructs, after the vehicle has transported the part, the vehicle to move from the supply destination to a stopover and to load another part at the stopover, and instructs the vehicle to deliver the other part to one or more delivery points located in a direction from the stopover toward the supplier.

2. The transportation management device according to claim 1, wherein the processor causes a common transporter to be used for transporting the part and delivering the other part.

3. The transportation management device according to claim 1, wherein the processor selects, from a plurality of vehicles heading for the supply destination, a vehicle that most fits a delivery plan from the stopover.

4. The transportation management device according to claim 3, wherein the processor selects, as the vehicle that most fits the delivery plan from the stopover, a vehicle that has agreed on delivery from the stopover.

5. The transportation management device according to claim 3, wherein the processor generates the delivery plan based on information on the other part.

6. The transportation management device according to claim 5, wherein the processor generates the delivery plan based on demand information of the other part as the information on the other part.

7. The transportation management device according to claim 6, wherein the processor generates the delivery plan based on the demand information obtained based on acquired malfunction information of another vehicle.

8. The transportation management device according to claim 6, wherein the processor generates the delivery plan based on the demand information obtained based on weather information.

9. The transportation management device according to claim 1, wherein when there is no other part to deliver, the processor makes an instruction that movement to the stopover is unnecessary to the vehicle.

10. A transportation management system, comprising:
the transportation management device according to claim 1; and
one or more vehicles that receive an instruction from the transportation management device.

11. A transportation management method that is performed through execution of processes by a processor, the processes comprising:
instructing a vehicle to transport a part from a supplier of the part to a supply destination;
instructing, after the vehicle has transported the part, the vehicle to move from the supply destination to a stopover and to load another part at the stopover; and
instructing the vehicle to deliver the other part to one or more delivery points located in a direction from the stopover toward the supplier.

12. A transportation management program that causes a computer to execute processes comprising:
instructing a vehicle to transport a part from a supplier of the part to a supply destination;
instructing, after the vehicle has transported the part, the vehicle to move from the supply destination to a stopover and to load another part at the stopover; and
instructing the vehicle to deliver the other part to one or more delivery points located in a direction from the stopover toward the supplier.
